(19) United States
(12) Patent Application Publication
(10) Pub. No.: US 2023/0024739 A1
(43) Pub. Date: Jan. 26, 2023

(54) FUEL CELL SYSTEMS AND METHOD

(71) Applicant: Ceres Intellectual Property Company Limited, Horsham (GB)

(72) Inventors: Richard William Cottrell, Brighton (GB); Pawel Mateusz Wachel, Horsham (GB)

(21) Appl. No.: 17/870,543

(22) Filed: Jul. 21, 2022

(30) Foreign Application Priority Data
Jul. 23, 2021 (GB) 2110632.3

(51) Int. Cl. H01M 8/0612; H01M 8/04082

(52) U.S. Cl. CPC H01M 8/0618; H01M 8/04201

(57) ABSTRACT

A fuel cell system including a fuel cell stack comprising at least one fuel cell and having an anode inlet, a cathode inlet, an anode off-gas outlet, a cathode off-gas outlet, and defining separate flow paths for flow of anode inlet gas, cathode inlet gas, anode off-gas and cathode off-gas. The fuel cell system further comprises a reformer for reforming a fuel to a reformate, the reformer comprising a reformer inlet for anode inlet gas, a reformer outlet for exhausting anode inlet gas, and a reformer heat exchanger. There is also provided a a pre-heater for heating cathode inlet gas, the cathode inlet gas pre-heater comprising a pre-heater inlet for cathode inlet gas, a pre-heater outlet for exhausting cathode inlet gas, and a pre-heater heat exchanger, and a heat source for providing heat source gas.

### FIELD OF THE INVENTION

The present invention relates to fuel cell systems and methods.

### BACKGROUND TO THE INVENTION

Teachings of fuel cells, fuel cell stacks, fuel cell stack assemblies, and heat exchanger systems, arrangements and methods are well known to one of ordinary skill in the art, and in particular include WO2008/015461, WO2008/053213, WO2008/104760, WO2008/132493, WO2009/090419, WO2010/020797, WO2010/061190, WO2015/004419A1 and publication “Evaluation of system configurations for solid oxide fuel cell-based micro-combined heat and power generators in residential applications” by R. J. Braun, S. A. Klein & D. T. Reindl, published in Journal of Power Sources (Volume 158, Issue 2, 25 August 2006, Pages 1290-1305), which are incorporated herein by reference in their entirety. Definitions of terms used herein can be found as necessary in the above publications.

Operating hydrocarbon fueled fuel cell systems, for example a SOFC (solid oxide fuel cell) system in which the fuel cell stack operates in the 450-650 C. range (intermediate-temperature solid oxide fuel cell; IT-SOFC), more particularly in the 520-620 C. temperature range, results in a challenging set of technical problems.

In such systems, steam reforming at a reformer is typically used to convert a hydrocarbon fuel stream (such as natural gas) into a hydrogen-rich reformate stream which is fed to the fuel cell stack anode inlet. The publication by J. Braun, S. A. Klein & D. T. Reindl discloses one such system (depicted in FIG. 1) in which a hydrocarbon fuel is reformed into a hydrogen-rich reformate stream before delivery to an anode inlet of the stack. In such systems, exhaust gases from the fuel cell are used to provide the heating needs of the reformer to reform the hydrocarbon fuel.

A typical steady-state operation of fuel cell systems (see FIG. 1) involves the supply of a natural gas such as methane to a reformer 134 for reforming into a fuel for a fuel cell stack 105. During operation the reformer is supplied heat, generated through the combustion of exhaust gases from the fuel cell—both from the fuel side (anode 120) and the air side (cathode 110) of the fuel cell, to facilitate a reforming reaction within the reformer. The produced hydrogen-rich reformate is subsequently fed to the fuel cell stack anode inlet 126. Excess heat from the reformer may be used to provide heat to other components of the fuel cell system. For example, the excess heat may be provided to a steam generator 137 located immediately downstream of the reformer and that is arranged to provide superheated steam for the reformer.

Some of these systems also use a partial oxidation (PDX) reactor in addition to a reformer to produce a hydrogen-rich stream from a hydrocarbon fuel supply for delivery to an anode inlet. JP2012243564 is an example of such a system, in which a hydrocarbon fuel supply is partially oxidised in a PDX reactor using an oxidant to produce molecular hydrogen and carbon monoxide. In JP2012243564 the output of the PDX reactor is fed into a steam reformer and subsequently to the anode inlet of the stack.

In addition to supplying the fuel cell with hydrogen, it is also necessary to ensure the chemical process occurring within the fuel cell is held at a suitable temperature. The conventional method for regulating the temperature within the fuel cell is via controlling the temperature of the inlet air and the flow rate on the cathode side of the fuel cell. In example of FIG. 1, the excess heat from the reformer 134 is also provided to a pre-heater 162 located immediately downstream of the steam generator 137 and that is arranged to heat the air before it is fed to the fuel cell stack cathode inlet 131.

In fuel cell systems where exhaust gasses are combusted to provide heat for both the reformer and the fuel cell's cathode side, a thermal balance has to be reached in terms of the amount of exhaust gas to be burnt, and the proportion of the resulting heat that should be used to heat the reformer and the cathode side of the fuel cell respectively. Failure to achieve said thermal balance can result in the fuel cell having a large thermal gradient across the anode and cathode. Large thermal gradients across fuel cells prevent optimal operation of the fuel cell, especially when the fuel cell is operating in a co-flow configuration (in which both the fuel and the oxidant flow in the same direction across their respective sides of the fuel cell).

The present invention seeks to address, overcome or mitigate at least one of the prior art disadvantages.

### SUMMARY OF THE INVENTION

According to the present invention there is provided a fuel cell system and method of operating a fuel cell system as defined in the appended independent claims. Further preferable features are defined in the appended dependent claims.

According to a first aspect of the present invention there is provided a fuel cell system including:
(i) at least one fuel cell stack comprising at least one fuel cell and having an anode inlet, a cathode inlet, an anode off-gas outlet, a cathode off-gas outlet, and defining separate flow paths for flow of anode inlet gas, cathode inlet gas, anode off-gas and cathode off-gas;
(ii) a reformer for reforming a fuel to a reformate, the reformer comprising a reformer inlet for anode inlet gas, a reformer outlet for exhausting anode inlet gas, and a reformer heat exchanger;
(iii) a pre-heater for heating cathode inlet gas, the cathode inlet gas pre-heater comprising a pre-heater inlet for cathode inlet gas, a pre-heater outlet for exhausting cathode inlet gas, and a pre-heater heat exchanger; and
(iv) a heat source for providing heat source gas; and defining:
(a) an anode inlet gas fluid flow path from a fuel source to said reformer to said at least one fuel cell stack anode inlet;
(b) an anode off-gas fluid flow path from said at least one fuel cell stack anode off-gas outlet to a fuel cell system exhaust;
(c) a cathode inlet gas fluid flow path from a cathode inlet gas source to said pre-heater to said at least one fuel cell stack cathode inlet;
(d) a cathode off-gas fluid flow path from said at least one fuel cell stack cathode off-gas outlet to said fuel cell system exhaust;
(e) a heat source gas main fluid flow path from said heat source to said reformer heat exchanger to said pre-heater heat exchanger; and
(f) a heat source gas bypass fluid flow path that splits from said heat source gas main fluid flow path upstream of the reformer heat exchanger and is arranged to divert a portion of said heat source gas around said reformer to said pre-heater heat exchanger;
wherein said reformer heat exchanger is arranged for exchanging heat between said anode inlet gas and said heat source gas; and wherein said pre-heater heat exchanger is arranged for exchanging heat between said cathode inlet gas and said heat source gas.

The heat source gas bypass fluid flow path splits or divides from said heat source gas main fluid flow path upstream of the reformer heat exchanger, thereby diverting a portion of said heat source gas around said reformer and preserving some higher grade heat within that portion. The heat source gas bypass fluid flow path acts to bypass (circumvent) said reformer heat exchanger. The heat source gas bypass fluid flow path may recombine with the heat source gas main fluid flow path downstream of the reformer heat exchanger and upstream of the pre-heater heat exchanger.

The heat source gas bypass fluid flow path may be defined by a bypass conduit that may intersect (or join) with a heat source gas main fluid flow passageway (defining said heat source gas main fluid flow path) at a bypass inlet located between said heat source and said reformer heat exchanger. Said bypass conduit may again intersect (or rejoin) with said heat source gas fluid flow passageway (defining said heat source gas main fluid flow path) at a bypass outlet located between said reformer heat exchanger and said pre-heater heat exchanger.

Said reformer heat exchanger may be in fluid flow communication with (i) said heat source and said pre-heater heat exchanger, and (ii) said fuel source and said at least one fuel cell stack anode inlet. Preferably, said pre-heater heat exchanger is in fluid flow communication with (i) said heat source and said fuel cell system exhaust, and (ii) said cathode inlet gas source and said at least one fuel cell stack cathode inlet.

The fuel cell system may be a solid oxide fuel cell (SOFC) system. The at least one fuel cell stack may then comprise at least one solid oxide fuel cell. The fuel cell system may be a metal-supported solid oxide fuel cell (MS-SOFC) system. The at least one fuel cell stack may then comprise at least one metal-supported solid oxide fuel cell (MS-SOFC). The fuel cell system may be a metal-supported intermediate-temperature solid oxide fuel cell system. The at least one fuel cell stack may then comprise at least one metal-supported intermediate-temperature solid oxide fuel cell.

The portion of said heat source gas that is diverted to said heat source gas bypass fluid flow path may be passively controlled. A bypass inlet may join said heat source gas main fluid flow path between said heat source and said reformer heat exchanger, and a bypass outlet join said heat source gas main fluid flow path between said reformer heat exchanger and said pre-heater heat exchanger. Said heat source gas bypass fluid flow path may comprise a constriction between said heat source gas bypass inlet and said heat source gas bypass outlet. Said constriction may comprise an orifice plate. A pressure drop across the heat source gas main fluid flow path between said bypass inlet and said bypass outlet may cause said portion of said heat source gas to flow around said reformer through said heat source gas bypass fluid flow path.

The fuel cell system may further comprise a passive flow splitter that provides passive control of the portion of said heat source gas that is diverted to said heat source gas bypass fluid flow path. The passive flow splitter may be provided by a junction between said heat source gas main fluid flow path and said heat source gas bypass fluid flow path. The passive flow splitter may be provided by a junction between said heat source gas main fluid flow path and said heat source gas bypass fluid flow path at a bypass inlet.

The fuel cell system may further comprise a steam generator for providing steam for the reformer, the steam generator comprising: a water inlet in fluid flow communication with a water source; a steam generator heat exchanger disposed in the heat source gas main fluid flow path between said reformer heat exchanger and said pre-heater heat exchanger, and arranged to exchange heat between said heat source gas and water from said water source thereby generating steam; and a steam outlet in fluid flow communication with said reformer.

A bypass outlet may join said heat source gas main fluid flow path between said steam generator and said pre-heater heat exchanger. A bypass outlet may join said heat source gas main fluid flow path between said reformer heat exchanger and said steam generator.

The portion of said heat source gas flowing through said heat source gas bypass fluid flow path may comprise, by volume, 10-25%, by volume, of the heat source gas.

The fuel cell stack may be configured to operate in a co-flow configuration, wherein the anode inlet gas flows from the anode inlet to the anode off-gas in the same direction as the cathode inlet gas flows from the cathode inlet to the cathode off-gas.

The heat source may comprise a burner in fluid flow communication with said at least one fuel cell stack anode and cathode off-gas outlets, and having a burner exhaust for exhausting heat source gas. Said heat source gas main fluid flow path may pass from said burner exhaust to said reformer heat exchanger to said pre-heater heat exchanger to said fuel cell system exhaust.

The anode off-gas fluid flow path may pass from said at least one fuel cell stack anode off-gas outlet to an anode off-gas inlet of said burner. The cathode off-gas fluid flow path may pass from said at least one fuel cell stack cathode off-gas outlet to a cathode off-gas inlet of said burner. The burner may define a fluid flow path from said at least one fuel cell stack anode and cathode off-gas outlets to said burner exhaust to said reformer heat exchanger to said pre-heater heat exchanger to said fuel cell system exhaust.

The heat source gas bypass fluid flow path may comprise a bypass conduit located between said heat source and said pre-heater inlet. An inlet of the bypass conduit may be connected to the heat source gas main fluid flow path between said heat source and said reformer heat exchanger. The inlet of the bypass conduit may have a smaller cross section than the heat source gas main fluid flow path. The bypass conduit may have an inlet and an outlet and a constriction between the inlet and the outlet for setting a pressure drop therebetween. An outlet of the bypass conduit may be connected to the heat source gas main fluid flow path between said reformer heat exchanger and said pre-heater heat exchanger. The outlet of the bypass conduit may be connected to the heat source gas main fluid flow path between an outlet of said steam generator and an inlet of said pre-heater heat exchanger. The outlet of the bypass conduit may be connected to the heat source gas main fluid flow path between an outlet of said reformer and an inlet of said steam generator

According to a second aspect of the present invention there is provided a method of operating a fuel cell system including at least one fuel cell stack comprising at least one fuel cell and having an anode inlet, a cathode inlet, an anode off-gas outlet, a cathode off-gas outlet, the method comprising the steps of:
(i) passing anode inlet gas from a fuel source to a reformer to said anode inlet;
(ii) passing cathode inlet gas from a cathode inlet gas source to a pre-heater to said cathode inlet;
(iii) passing a heat source gas from a heat source to a reformer heat exchanger of said reformer such that heat is exchanged between said heat source gas and said anode inlet gas; and
(iv) allowing a portion of said heat source gas from said heat source to bypass said reformer and pass to a pre-heater heat exchanger of said pre-heater such that heat is exchanged between said portion of said heat source gas and said cathode inlet gas.

### BRIEF DESCRIPTION OF THE DRAWINGS

FIG. 1 is a schematic of a prior art fuel cell system.

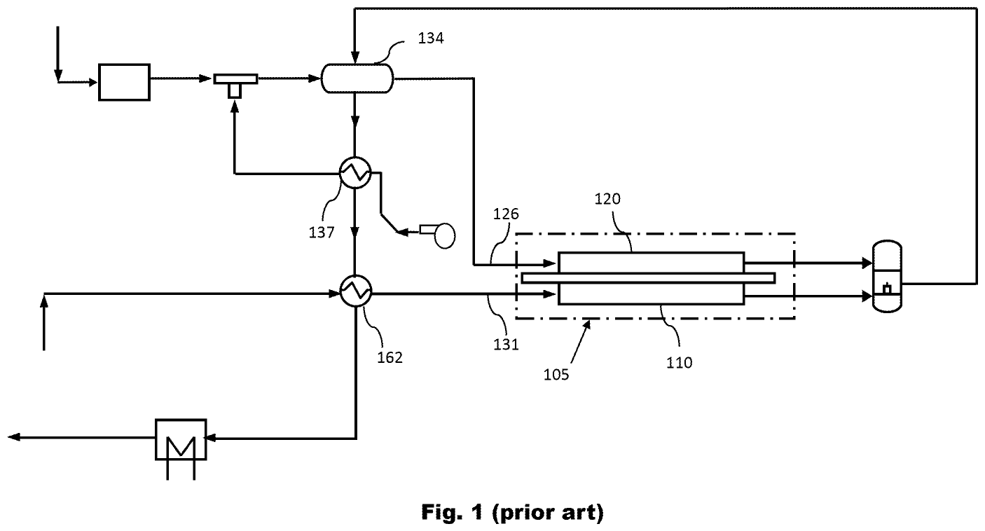

FIG. 2 is a schematic of a fuel cell system in accordance with the present invention.

FIG. 3 is a schematic of a fuel cell system in accordance with the present invention.

FIG. 4 is a schematic of an inlet of a bypass of fuel cell system in accordance with the present invention.

FIG. 5 is a schematic of an outlet of a bypass of fuel cell system in accordance with the present invention.

FIG. 6 illustrates a method of operating a fuel cell system in a steady state in accordance with the present invention.

In the following figures and description like reference numerals will be used for like elements in different figures.

### DETAILED DESCRIPTION

For illustrative purposes only, the figures only indicate a single fuel cell. In various embodiments, multiple fuel cells are provided. In further embodiments (not shown) multiple fuel cell stacks are provided, and in still further embodiments multiple fuel cell stacks each comprising multiple fuel cells are provided. It will be appreciated that the anode and cathode inlets, outlets (off-gas), ducting, and manifolding, and their configuration are modified as appropriate for such embodiments, and will be readily apparent to a person of ordinary skill in the art.

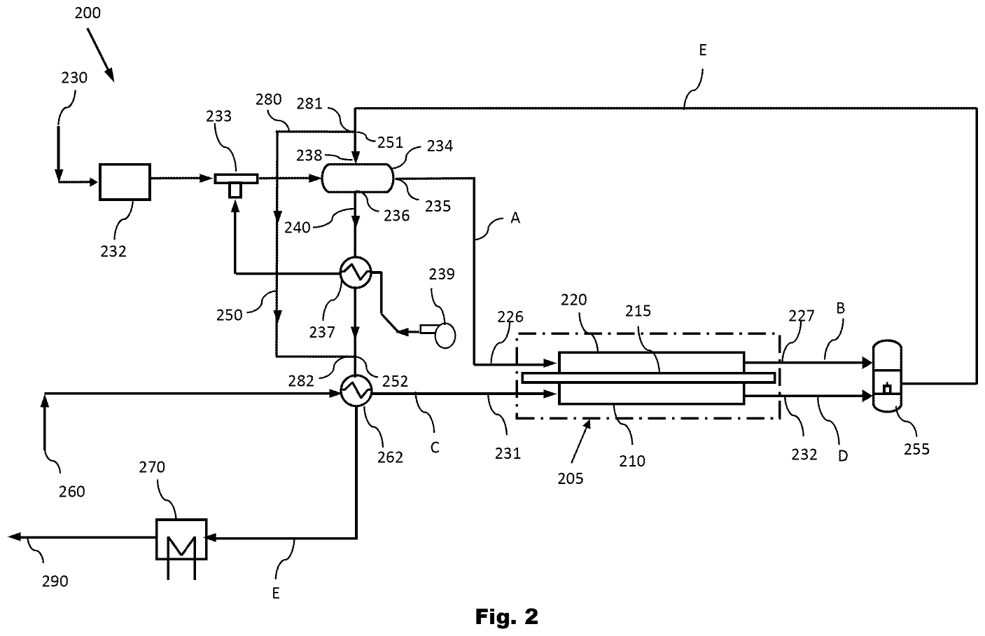

Referring to FIG. 2, a schematic of a fuel cell system 200 is shown. The fuel cell system 200 includes a stack 205 of fuel cell units, also referred to as a “fuel cell stack”. A plurality of cell units forms the stack of cell units. Each cell unit includes an anode 220, a cathode 210, and an electrolyte 215 positioned between the anode 220 and cathode 210. The anode 220, electrolyte 215, and cathode 210 may together be referred to as the electrochemically active layer, active electrochemical cell layer, or electrochemically active region. The electrolyte 215 conducts either negative oxygen ions or positive hydrogen ions between the anode 220 and cathode 210. The stack 205 may comprise a stack of fuel cell units that are based on one of solid oxide electrolytes, polymer electrolyte membranes, or molten electrolytes or any other variant capable of electrochemistry.

Each cell unit in the stack is separated by an electrically conducting gas impermeable metal interconnect plate (interconnect) (not shown). The interconnect plate separates an oxidant fluid volume from a fuel fluid volume in each cell unit of the stack, and will usually be provided with a 3D contoured construction, for example, comprising a pattern of spaced channels and ribs, or spaced dimples, to control fluid flow. The interconnect plate between adjacent cell units in the stack may be coated on the side facing the anode of a given cell unit with a catalyst configured to catalyse steam reforming of unreformed hydrocarbon fuels to produce hydrogen gas within the stack. The reforming catalyst may be referred to as an internal reformer. In an example, each cell unit in the stack is separated from an adjacent cell unit by an interconnect structure (e.g. the separator and/or interconnect referred to above), the interconnect structure having a coating on a side facing and in fluidic communication with the anode of the adjacent cell unit, the coating comprising the reforming catalyst and configured to reform fuel to hydrogen for use in the stack. The reforming catalyst may be a steam reforming catalyst, for example platinum and/or rhodium. This catalyst may also catalyse cracking during start up above the first threshold temperature when negligible water is present.

In the example of FIG. 2, each cell unit is a metal-supported solid oxide fuel cell in which the solid oxide electrolyte is supported by a metal substrate plate (not shown), and may therefore be referred to as metal-supported solid oxide fuel cell (MS-SOFC). The metal substrate plate supports the electrochemically active layer (i.e. in which an electrochemical reaction occurs during operation) bonded thereto, which may be coated, deposited or otherwise affixed thereto, and so the cell unit may be referred to as a metal supported cell unit. Specifically, each cell unit is a metal supported intermediate-temperature solid oxide fuel cell (IT-SOFC) fuel cell, as taught in U.S. Pt. No. 6,794,075.

The fuel cell stack 205 has an anode inlet 226, a cathode inlet 231, an anode off-gas outlet 227, a cathode off-gas outlet 232, and defines separate flow paths for flow of anode inlet gas (i.e. fuel), cathode inlet gas (i.e. an oxidant), anode off-gas and cathode off-gas. The fuel cell system 200 operates in a co-flow configuration, wherein the anode inlet gas flows through each cell from the anode inlet to the anode off-gas in the same direction as the cathode inlet gas flows from the cathode inlet to the cathode off-gas.

Fuel cell system 200 further comprises a reformer 234 for reforming an unreformed hydrocarbon fuel to a reformate and a pre-heater 262 (also known as an air pre-heater) for heating cathode inlet gas (i.e. oxidant). The reformer 234 comprises a reformer inlet for anode inlet gas, a reformer outlet for exhausting anode inlet gas, and a reformer heat exchanger. In this particular embodiment, the reformer heat exchanger is a parallel or co-flow heat exchanger. The pre-heater 262 comprises a pre-heater inlet for cathode inlet gas, a pre-heater outlet for exhausting cathode inlet gas, and a pre-heater heat exchanger. Fuel cell system 200 then further comprises a heat source 255 for providing hot gas to one or more other components of the fuel cell system 200.

An anode inlet gas fluid flow path A is defined from a fuel source to the reformer 234 to the stack anode inlet 226. An anode off-gas fluid flow path B is defined from the stack anode off-gas outlet 227 to a fuel cell system exhaust 290. A cathode inlet gas fluid flow path C is defined from a cathode inlet gas source to a pre-heater 262 to the stack cathode inlet 231. A cathode off-gas fluid flow path D is defined from the stack cathode off-gas outlet 232 to the fuel cell system exhaust 290. Fuel cell system 200 further comprises a heat source gas fluid flow path E from the heat source 255 to the fuel cell system exhaust 290 via at least the reformer heat exchanger and the pre-heater heat exchanger.

Fuel cell system 200 then comprises a fuel inlet 230 which is configured for connection to the fuel source (not shown) that provides a supply of unreformed hydrocarbon fuel, with the fuel inlet 230 being in fluid flow communication with the reformer 234. A desulfurizer 232 and/or a mixer 233 may also be located in the anode inlet gas fluid flow path A upstream of the reformer 234. An anode inlet gas outlet 235 of the reformer 234 is in fluid flow communication with the anode inlet 226 of the stack 205 for distribution of reformed fuel, within the stack 205, to the anode-side (also referred to as fuel volume) of the cell units within the stack 205. The anode off-gas outlet 227 of the stack 205 provides an exhaust to the stack and allows removal of fluid from the anode-side of the cell units within the stack 205. The anode off-gas outlet 227 is in fluid flow communication with the burner 255 such that the anode off-gas is routed to the burner 255 via anode off-gas fluid flow path B.

Fuel cell system 200 further comprises an oxidant inlet 260, which is configured for connection to the cathode inlet gas source (not shown), with the oxidant inlet 260 being in fluid flow communication with the pre-heater 262. The oxidant may, for example, be air or oxygen. The oxidant inlet 260 provides oxidant to the pre-heater 262, and the pre-heater outlet is then in fluid flow communication with the cathode inlet 231 of the stack 205 for distribution of heated oxidant, within the stack 205, to the cathode-side (also referred to as oxidant volume) of the cell units within the stack 205. The cathode off-gas outlet 232 of the stack 205 provides an exhaust to the stack 205 and allows removal of fluid from the cathode-side of the cell units within the stack 205. The cathode off-gas outlet 232 is in fluid flow communication with the burner 255 such that the cathode off gas is routed to the burner 255 via cathode off-gas fluid flow path D.

In FIG. 2 the heat source is provided by a burner 255, such as a tail-gas burner or swirl burner, that is in fluid flow communication with the stack anode and cathode off-gas outlets 227, 232, and has a burner exhaust for exhausting hot gas as a source of heat. The burner 255 is configured to combust any remaining combustible fuel in the anode off gas and oxidant in the cathode off gas. The hot gases generated by the combustion are exhausted from the burner 255 and recirculated through one or more other components of the fuel cell system 200 via the heat source gas fluid flow path E before being exhausted from the fuel cell system exhaust 290. Consequently, in this embodiment, the anode off-gas fluid flow path B, the cathode off-gas fluid flow path D, and the heat source gas fluid flow path E have common components and share a common flow path from the burner 255 to the fuel cell system exhaust 290.

The fuel cell system 200 further comprises a steam generator 237 for generating steam using water supplied by a water source through water inlet 239. The steam generator 237 is located immediately downstream of the fuel reformer 234. The steam produced by the steam generator 237 is exhausted from a steam outlet (not shown) and routed to the mixer 233. The hot gases carrying any remaining waste heat exit from the steam generator 237 via a waste heat exhaust (not shown) and are routed to the pre-heater 262. The hot gases carrying any remaining waste heat exit from the pre-heater 262 via a waste heat exhaust and are routed to a heat recovery unit 270 before being exhausted from the fuel cell system exhaust 290.

Steady state operating conditions may be characterised by a steady state stack temperature in the range of 400 to 1000 C., preferably 450 to 800 C., preferably 500 to 650 C. During steady state operation, as the reformer 234 is upstream of the pre-heater 262 in the heat source gas fluid flow path E, a situation may arise where there is not sufficient heat energy available to both reform the hydrocarbon fuel and sufficiently heat the oxidant. However, providing there is sufficient margin in the amount of heat needed by the reformer 234, it is possible to divert a portion of the heat source gas past the reformer 234, directly to the pre-heater 262. The fuel cell system 200 therefore comprises a heat source gas main fluid flow path 240 and a heat source gas bypass fluid flow path 250. The heat source gas main fluid flow path 240 is defined from the heat source 255 to the reformer heat exchanger to the pre-heater heat exchanger to the fuel cell system exhaust 290. The heat source gas bypass fluid flow path 250 then splits from the heat source gas main fluid flow path 240 upstream of the reformer 234 and is arranged to divert a portion of the heat source gas around the reformer 234 to the pre-heater heat exchanger. The heat source gas bypass fluid flow path 250 is therefore in fluid communication with the heat source and the pre-heater heat exchanger, whilst circumventing the reformer 234. The heat source gas fluid flow path E therefore branches into both the heat source gas main fluid flow path 240 and the heat source gas bypass fluid flow path 250.

The portion of the heat source gas that is diverted through the heat source gas bypass fluid flow path 250 is passively controlled, without the need for any sensors, control electronics, mechanical valves etc. as would be required to actively control how much of the heat source gas is diverted through the heat source gas bypass fluid flow path 250. Specifically, the heat source gas bypass fluid flow path 250 is configured to induce a gas stream ratio between the heat source gas main fluid flow path 240 and the heat source gas bypass fluid flow path 250, to allow a suitable balance between the reforming process and the air stream heating. The fuel cell system 200 therefore comprises a passive flow splitter 251 that splits the flow of heat source gas between the heat source gas main fluid flow path 240 and the heat source gas bypass fluid flow path 250. The heat source gas main fluid flow path 240 and the heat source gas bypass fluid flow path 250 then have common components and share a common flow path from the heat source 255 to the flow splitter 251. The fuel cell system 200 may then be configured such that a pressure drop across the heat source gas bypass fluid flow path 250 relative to a pressure drop across the heat source gas main fluid flow path 240 achieves the desired gas stream ratio.

To passively control the portion of the heat source gas that is diverted through the heat source gas bypass fluid flow path 250, at least a portion of the heat source gas bypass fluid flow path 250 may be configured with a smaller cross section than the heat source gas main fluid flow path 240. By virtue of a pressure drop across the reformer 234, a portion of the heat source gas will then flow around the reformer 234 through the heat source gas bypass fluid flow path 250. Alternatively, or in addition, the heat source gas bypass fluid flow path 250 may be configured with a constriction for setting a pressure drop across the heat source gas bypass fluid flow path 250. For example, the constriction may be an orifice plate. Alternatively, the constriction may be provided by a crimp formed in the heat source gas bypass fluid flow path 250.

The fuel cell system 200 may also comprise a passive flow combiner 252 that recombines the flow of heat source gas through the heat source gas bypass fluid flow path 250 with that through the heat source gas main fluid flow path 240. The heat source gas main fluid flow path 240 and the heat source gas bypass fluid flow path 250 may then also have common components and share a common flow path from the flow combiner 252 to the fuel cell system exhaust 290.

During operation, the heat source gas bypass fluid flow path 250 provides a mechanism for reducing the temperature gradient across the fuel cell stack 205 to enhance the operational performance of the fuel cell stack 205. By providing the heat source gas bypass fluid flow path 250, a portion of heat source gas is diverted away from the reformer 234 to the pre-heater 262, which acts to heat the oxidant entering the fuel cell stack 205 via the cathode inlet 231, thereby increasing the temperature on the cathode side of the fuel cell stack. Diverting a portion of heat source gas away from the reformer 234 can also reduce the temperature of the resulting reformed fuel entering the fuel cell stack 205 at the anode inlet 226.

In FIG. 2, the heat source gas bypass fluid flow path 250 comprises a bypass conduit 280. The bypass conduit 280 has a bypass inlet 281 that joins the heat source gas fluid flow path E between the burner 255 and the reformer 234, and a bypass outlet 282 that joins the heat source gas fluid flow path E between the steam generator 237 and the pre-heater 262. By positioning the bypass outlet 282 before the pre-heater 262 a portion of the exhaust gas from the burner 255 can be redirected around the reformer 234 to the pre-heater 262. The heat source gas bypass fluid flow path 250 is then defined between the bypass inlet 281 and the bypass outlet 282.

To passively control the portion of the heat source gas that is diverted through the bypass conduit 280, the bypass inlet 281 may have a smaller cross section than the heat source gas main fluid flow path 240. Alternatively, or in addition, the bypass conduit 280 may have a constriction between the bypass inlet 281 and the bypass outlet 282.

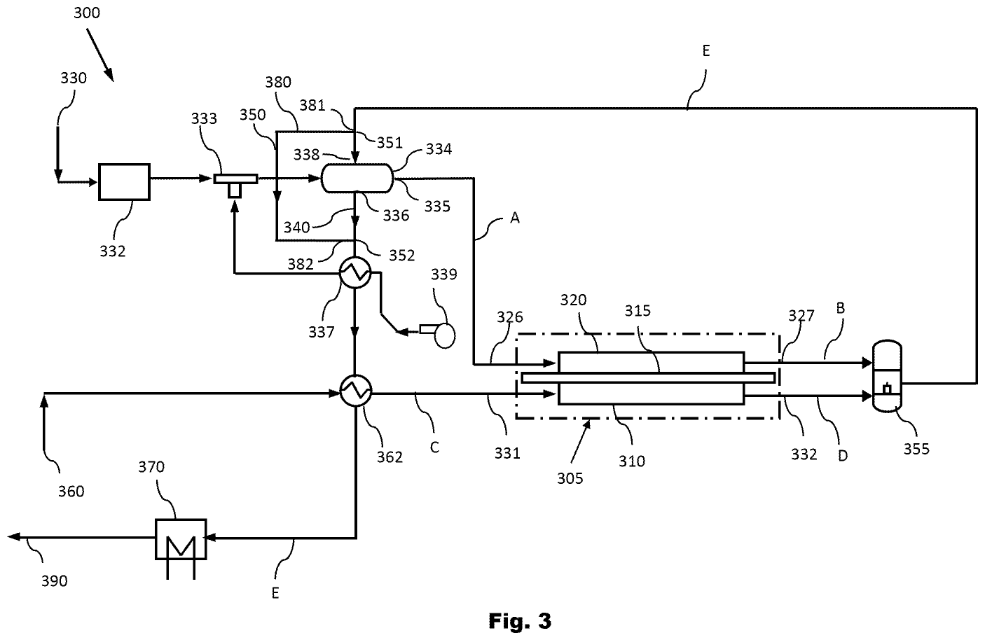

Referring to FIG. 3, a schematic of a fuel cell system 300 is shown. Fuel cell system 300 is a variant of the fuel cell system 200 of FIG. 2. Fuel cell system 300 is substantially the same as the fuel cell system 200; however the bypass conduit 380 of the fuel cell system 300 is configured differently to that of the fuel cell system 300. As before, the bypass conduit 380 has a bypass inlet 381 that joins the heat source gas fluid flow path E between the burner 355 and the reformer 334. The bypass outlet 382 then joins the heat source gas fluid flow path E between the reformer 334 and the steam generator 337 . By positioning the bypass outlet 382 before the steam generator 337 a portion of the heat source gas from the burner 355 can be redirected around the reformer 234 to the steam generator 337 and then on to the pre-heater 362. The heat source gas bypass fluid flow path 350 is then defined between the bypass inlet 381 and the bypass outlet 382.

As before, the bypass conduit 380 may be configured with a smaller cross section than the heat source gas main fluid flow path 340. Alternatively, or in addition, bypass conduit 380 may be configured with a constriction (such as an orifice plate or a crimped section) for setting a pressure drop across the heat source gas bypass fluid flow path 350.

During operation, the heat source gas bypass fluid flow path 350 provides a mechanism for reducing the temperature gradient across the fuel cell stack 305 to enhance the operational performance of the fuel cell stack 305. By providing the heat source gas bypass fluid flow path 350, a portion of heat source gas is diverted away from the reformer 334 to the steam generator 337, which boils water from the water inlet 339. Steam produced from boiling the water is directed to the mixer 333 for mixing with unreformed fuel prior to entering the reformer 334. Any excess heat that is not consumed by the steam generator 337 is subsequently directed to the pre-heater 362 for heating the oxidant prior to it entering the fuel cell stack 305. Thus diverted heat source gas first passes through the steam generator 337 and then onto the pre-heater 362, thereby indirectly increasing the temperature on the cathode side of the fuel cell.

In both the fuel cell system 200 and the fuel cell system 300 the portion of the heat source gas flowing through the heat source gas bypass fluid flow path 250; 350 may comprise 10-25% by volume of the heat source gas. Preferably the portion of the heat source gas flowing through the heat source gas bypass fluid flow path 250; 350 may comprise, by volume, about 18-22%, more preferably around 20% of the heat source gas.

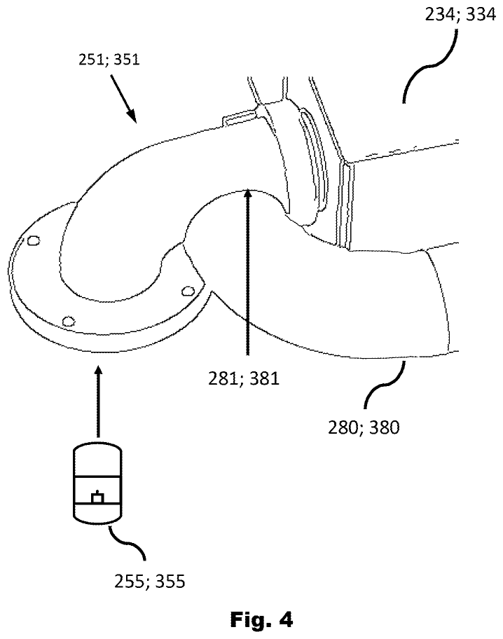

Referring to FIG. 4 a schematic of an inlet of the heat source gas bypass fluid flow path 250; 350 of fuel cell system 200 and fuel cell system 300 is shown. The heat source gas bypass fluid flow path 250; 350 comprises a bypass conduit 280; 380 having a first end that connects to a pipeline that provides a portion of the heat source gas fluid flow path E between the burner 255; 355 and the reformer 234; 334. Referring to FIG. 4 the connection between the pipeline and the first end of the bypass conduit 280; 380 forms a ‘T’ junction that acts as a passive flow splitter 251; 351 and provides the inlet to the heat source gas bypass fluid flow path 250; 350. However, other types of connection/junction which are known to the skilled person are possible.

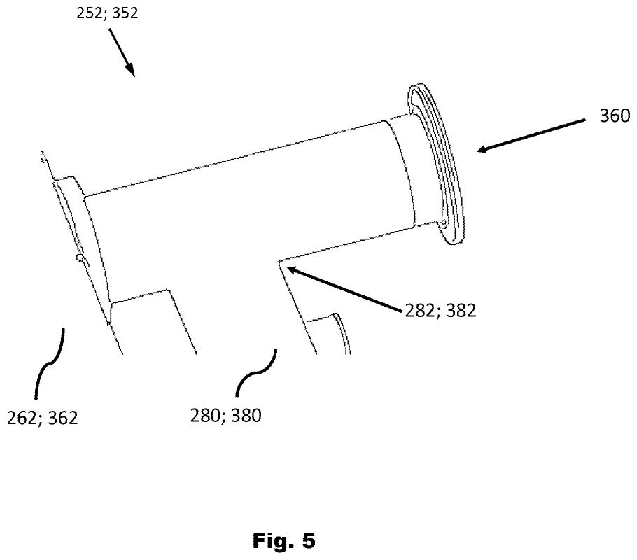

Referring to FIG. 5 a schematic of an outlet of the heat source gas bypass fluid flow path 250; 350 of fuel cell system 200 and fuel cell system 300 is shown. A second end of the bypass conduit 280; 380 connects to a pipeline that provides a portion of the heat source gas fluid flow path E between either:
i) an outlet (not shown) of the steam generator 237; 337 and an inlet (not shown) of the pre-heater 262; 362 (FIG. 2); or
ii) an outlet 236; 336 of the reformer 234; 334 and the inlet of the steam generator 237; 337 (FIG. 3).

Referring to FIG. 5 the connection between the pipeline and the second end of the bypass conduit 280; 380 forms a ‘T’ junction that acts as a passive flow combiner 252; 352 and provides the outlet from the heat source gas bypass fluid flow path 250; 350. However, other types of connection/junction which are known to the skilled person are possible.

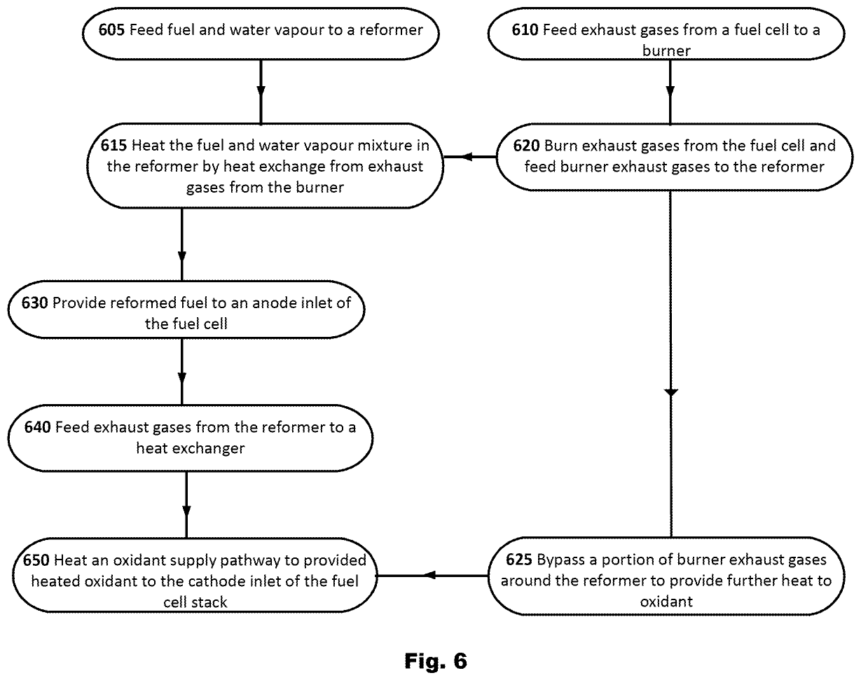

Referring to FIG. 6 a flow diagram depicting a method of operating a fuel cell system in a steady state, the fuel cell system having a fuel cell stack with an anode inlet, a cathode inlet, an anode off-gas outlet, and a cathode off-gas outlet,. The method depicted in FIG. 6 applies to fuel cell systems such as the fuel cell systems of FIG. 2 and FIG. 3.

During steady state operation, at step 605 unreformed fuel from a fuel inlet 230; 330 is supplied to a reformer 234; 334 either directly without passing through any other components of the fuel cell system, or indirectly via passing through other components first such as a desulfurizer 232; 332 and/or a mixer 233; 333. The reformer 234; 334 is also supplied with water vapour. The water vapour and unreformed fuel may be supplied to the reformer 234; 334 by a mixer 233; 333 where the water vapour and unreformed fuel are initially mixed together. The water vapour supplied to the reformer 234; 334 and/or the mixer 233; 333 may be produced by a steam generator 237; 337 that boils water from a water inlet 239; 339. The steam generator 237; 337 may be heated using waste heat from the reformer 234; 334. Alternatively, the steam generator 237; 337 used to produce the vapour may use an alternate source of heat to function.

At step 610, which may occur concurrently with step 605, exhaust gases from the fuel cell stack 205; 305 (from both the cathode side and the anode side) are fed to a burner 255; 355 to be combusted.

At step 615 the unreformed fuel and water vapour that has been fed to the reformer 234; 334 is heated to reform the unreformed fuel. The heat provided to the reformer 234; 334 may be provided at step 620 by at least a portion of the heat source gases exhausted from the burner 255; 355 that has combusted the exhaust gases from the fuel cell stack 205; 305 (from both the cathode side and the anode side).

At step 625 a portion of the heat source gas exhausted from the burner 255; 355 is diverted via a heat source gas bypass fluid flow path 250; 350, around the reformer 234; 334 to provide further heat to an oxidant for the fuel cell stack 205; 305. The heat source gas exhausted from the burner 255; 355 may be diverted via a bypass conduit 280; 380 to a pre-heater 262; 362, for heating the oxidant supplied to the fuel cell stack 205; 305. Alternatively, the heat source gas exhausted from the burner 255; 355 may be diverted via the bypass conduit 280; 380 to the steam generator 237; 337 to provide further heat to the steam generator 237; 337 for the production of water vapour for use in the reformer 234; 334.

At step 630 the reformed fuel (i.e. anode inlet gas) produced by the reformer 234; 334 is passed to an anode inlet 226; 326 of the fuel cell stack 205; 305. At the same time a heated oxidant (i.e.

cathode inlet gas) is passed to a cathode inlet 231; 321 of the fuel cell stack 205; 305 in a co-flow configuration such that the reformed fuel and the oxidant flow in the same direction across their respective sides of the fuel cell stack 205; 305.

The oxidant that flows to the cathode inlet 231; 331 of the fuel cell stack 205; 305 is heated by a heat exchanger of pre-heater 262; 362 at step 650, wherein the oxidant is heated by both the heat source gas exhausted from the reformer 234; 334, and the portion of the heat source gas bypassed around the reformer 234; 334 via the heat source gas bypass fluid flow path 250; 350. In the case of the heat source gas exhausted from the reformer 234; 334, this may be fed directly to the pre-heater 262; 362 or may first pass through other components such as the steam generator 237, 337. In the latter case, surplus heat source gas exhausted from the steam generator 237, 337 is provided to the pre-heater 262; 362 to heat the oxidant.

The present invention is not limited to the above examples only, and other examples will be readily apparent to one of ordinary skill in the art without departing from the scope of the appended claims.

These and other features of the present invention have been described above purely by way of example. Modifications in detail may be made to the invention within the scope of the claims.

By way of example, in the embodiments shown in FIG. 2 and FIG. 3, a burner 255; 355 is used as a heat source for the reformer 234; 334, the steam generator 237; 337, and the pre-heater 262; 362 before being exhausted from the fuel cell system exhaust 290. However, in an alternative embodiment an auxiliary heat source could be used to provide heat source gas to the reformer 234; 334, the pre-heater 262; 362, and optionally the steam generator 237; 337.

1. A fuel cell system comprising:
(i) at least one fuel cell stack comprising at least one fuel cell and having an anode inlet, a cathode inlet, an anode off-gas outlet, a cathode off-gas outlet, and defining separate flow paths for flow of anode inlet gas, cathode inlet gas, anode off-gas and cathode off-gas;
(ii) a reformer for reforming a fuel to a reformate, the reformer comprising a reformer inlet for anode inlet gas, a reformer outlet for exhausting anode inlet gas, and a reformer heat exchanger;
(iii) a pre-heater for heating cathode inlet gas, the cathode inlet gas pre-heater comprising a pre-heater inlet for cathode inlet gas, a pre-heater outlet for exhausting cathode inlet gas, and a pre-heater heat exchanger; and
(iv) a heat source for providing heat source gas;
and defining:
(a) an anode inlet gas fluid flow path from a fuel source to said reformer to said at least one fuel cell stack anode inlet;
(b) an anode off-gas fluid flow path from said at least one fuel cell stack anode off-gas outlet to a fuel cell system exhaust;
(c) a cathode inlet gas fluid flow path from a cathode inlet gas source to said pre-heater to said at least one fuel cell stack cathode inlet;
(d) a cathode off-gas fluid flow path from said at least one fuel cell stack cathode off-gas outlet to said fuel cell system exhaust;
(e) a heat source gas main fluid flow path from said heat source to said reformer heat exchanger to said pre-heater heat exchanger; and
(f) a heat source gas bypass fluid flow path that splits from said heat source gas main fluid flow path upstream of the reformer heat exchanger and is arranged to divert a portion of said heat source gas around said reformer to said pre-heater heat exchanger;
wherein said reformer heat exchanger is arranged for exchanging heat between said anode inlet gas and said heat source gas; and
wherein said pre-heater heat exchanger is arranged for exchanging heat between said cathode inlet gas and said heat source gas.

2. The fuel cell system according to claim 1, wherein the portion of said heat source gas that is diverted to said heat source gas bypass fluid flow path is passively controlled.

3. The fuel cell system according to claim 1, wherein at least a portion of said heat source gas bypass fluid flow path has a smaller cross section than said heat source gas main fluid flow path.

4. The fuel cell system according to claim 1, wherein a bypass inlet joins said heat source gas main fluid flow path between said heat source and said reformer heat exchanger, and a bypass outlet joins said heat source gas main fluid flow path between said reformer heat exchanger and said pre-heater heat exchanger.

5. The fuel cell system according to claim 4, wherein said heat source gas bypass fluid flow path comprises a constriction between said bypass inlet and said bypass outlet.

6. The fuel cell system according to claim 4, wherein a pressure drop across the heat source gas main fluid flow path between said bypass inlet and said bypass outlet causes said portion of said heat source gas to flow around said reformer through said heat source gas bypass fluid flow path.

7. The fuel cell system according to claim 1, and comprising a passive flow splitter that provides passive control of the portion of said heat source gas that is diverted to said heat source gas bypass fluid flow path.

8. The fuel cell system according to claim 7, wherein the passive flow splitter is provided by a junction between said heat source gas main fluid flow path and said heat source gas bypass fluid flow path.

9. The fuel cell system according to claim 1, and further comprising a steam generator for providing steam for the reformer, the steam generator comprising:
a water inlet in fluid flow communication with a water source;
a steam generator heat exchanger disposed in the heat source gas main fluid flow path between said reformer heat exchanger and said pre-heater heat exchanger, and arranged to exchange heat between said heat source gas and water from said water source thereby generating steam; and
a steam outlet in fluid flow communication with said reformer.

10. The fuel cell system according to claim 9, wherein a bypass outlet joins said heat source gas main fluid flow path between said steam generator and said pre-heater heat exchanger.

11. The fuel cell system according to claim 9, wherein a bypass outlet joins said heat source gas main fluid flow path between said reformer heat exchanger and said steam generator.

12. The fuel cell system according to claim 1, wherein the portion of said heat source gas flowing through said heat source gas bypass fluid flow path comprises 10-25%, by volume, of the heat source gas.

13. The fuel cell system according to claim 1, wherein the heat source comprises a burner in fluid flow communication with said at least one fuel cell stack anode and cathode off-gas outlets, and having a burner exhaust for exhausting heat source gas.

14. The fuel cell system according to claim 13, wherein said heat source gas main fluid flow path passes from said burner exhaust to said reformer heat exchanger to said pre-heater heat exchanger to said fuel cell system exhaust.

15. A method of operating a fuel cell system including at least one fuel cell stack comprising at least one fuel cell and having an anode inlet, a cathode inlet, an anode off-gas outlet, a cathode off-gas outlet, the method comprising the steps of:
(i) passing anode inlet gas from a fuel source to a reformer to said anode inlet;
(ii) passing cathode inlet gas from a cathode inlet gas source to a pre-heater to said cathode inlet;
(iii) passing a heat source gas from a heat source to a reformer heat exchanger of said reformer such that heat is exchanged between said heat source gas and said anode inlet gas; and
(iv) allowing a portion of said heat source gas from said heat source to bypass said reformer and pass to a pre-heater heat exchanger of said pre-heater such that heat is exchanged between said portion of said heat source gas and said cathode inlet gas.
